(19) United States
(12) Patent Application Publication
(10) Pub. No.: US 2005/0275213 A1
(43) Pub. Date: Dec. 15, 2005

(54) Peel-back overlapping label

(75) Inventors: Peter Whitehouse, Mississauga (CA); Edward Paul Braband, Webster, NY (US); Brad James Phelps, Webster, NY (US)

Correspondence Address: BROWN & MICHAELS, PC;400 M & T BANK BUILDING, 118 NORTH TIOGA ST, ITHACA, NY, 14850, US

(73) Assignee: Tapecon, Inc, Buffalo, NY (US)

(21) Appl. No.: 10/867,227

(22) Filed: Jun. 14, 2004

(51) Int. Cl. B42D 15/00

(52) U.S. Cl. 283/81

(57) ABSTRACT

This peel-back overlapping label has excess label panels that overlap the portion of the label adhered to the bottle. It uses a “breakaway” system rather than a “release” system to keep the excess label panels from adhering to the portions adhered to the bottle surface. The label is first run in standard fashion with pressure sensitive adhesive on the reverse/back side and a normal printed message on the outward/front side. Then, the printed surfaces to be overlapped receive an additional impress/coating of transparent extender “printed” over the already printed surface. This extender coat can form a full or partial breakaway surface, effectively neutralizing all or almost all of the tackiness of the adhesive on the overlapping label portions. The breakaway surface can be printed so as to leave a peripheral area free to adhere, leave an edge portion free from adhesive so as to provide a grab and peel edge for the user, and to have some interior unprinted portions to aid in maintaining open-and-shut adhesion.

### FIELD OF THE INVENTION

My invention relates generally to the field of labels, and more particularly to labels applied to bottles used for supplements, pharmaceuticals and cosmetics.

### BACKGROUND OF THE INVENTION

Labels for supplements and pharmaceuticals (jointly referred to as “nutraceuticals”) have become more and more detailed as required by increasing regulation and customer demand. This initially resulted in increasingly small print being used. After this reached its limit, different ways of producing expanded label space with “outserts” (as opposed to “inserts”) became increasingly common. However, such methods are cumbersome and inefficient. Thus, there remains a great need for methods and means of expanding the amount of information that can be conveyed by label without gross changes in the manner in which labels are produced and applied.

### SUMMARY OF THE INVENTION

My invention relies on several important innovations to supercede prior art in this area. In its preferred embodiments it is based on overlapping a standard wrap-around label. (Thus, whereas a standard label typically might have four panels, my label would have five or more, with excess label panels overlapping the portion of the label adhered to the bottle.) However, it could also be used with overlapping labels that did not wrap around a container—e.g.—label panels applied to the back of a box. In my invention, a “breakaway” material is used between the overlap and the remaining portions of the label (rather than a “release” layer/material) to keep the excess label panels from adhering to the portions adhered to the bottle surface. More importantly, the nature of the breakaway material used is truly unique-allowing it to be printed on the upper surface of the overlapped portions of the label.

I have discovered that the extender used in ink provides an excellent printable breakaway surface. Extender is basically transparent ink base without any particular color pigment added. It is used in printing to bring a particular ink to the right consistency. Thus, in my invention a label can be run in standard fashion with pressure sensitive adhesive on its back side and a normal printed message on its front side. Then, the printed surfaces to be overlapped receive an additional impress/coating of transparent extender “printed” over the printed surfaces to form a breakaway imprint. This extender coat can form a full or partial breakaway surface, effectively neutralizing all or almost all of the tackiness of the adhesive on the overlapping label portions.

I have also found it useful to print the extender in certain patterns for the purposes of this invention. (This process is facilitated by the fact that the breakaway substance used in my invention is printable.) Thus, the breakaway imprint is usually printed so as to (a) leave a peripheral area free to adhere, (b) leave an edge portion free from adhesive so as to provide a grab and peel edge for the user, and (c) to have some interior unprinted portions to aid in maintaining open-and-shut adhesion. When done in this way, the excess panels can be easily and repeatedly peeled back and pressed back into position.

Finally, the addition of a clear laminate layer to the upper surface of the label over the breakaway imprint makes it possible to also place a message or information on the underside of the overlapping portion. The breakaway imprint on the overlapped portion prevents the clear laminate from adhering to the portions of the label covered by the breakaway imprint, but not to the adhesive on the bottom surface of the overlap. A die cut made through the clear laminate between the portion overlaying the breakaway imprint and the remainder of the laminate allows the overlap (with its adhesive covered by the clear laminate) to be pulled away from the overlapped portion of the label. The top of the clear laminate overlaying the breakaway imprint can be printed in mirror image prior to application of the adhesive backed overlap to this surface. After the clear laminate has adhered to the bottom of the overlap, this printing will remain visible, turning the inside as well as the outside of the overlap into a surface capable of bearing printed information.

### BRIEF DESCRIPTION OF DRAWINGS

FIG. 1 provides a schematic perspective view of a label produced in accordance with the teachings of my invention applied to a nutraceutical bottle. An overlap panel of this label has been peeled back and its adhesive backing is partially or fully deadened by a portion of the breakaway imprint adhering thereto.

FIG. 2A provides a schematic cross-sectional view of a label produced in accordance with the teachings of my invention applied to a nutraceutical bottle. An overlap panel of this label has been peeled back and its adhesive backing is partially or fully deadened by a portion of the breakaway imprint adhering thereto.

FIG. 2B provides a schematic elevational view of a label produced in accordance with the teachings of my invention prior to its application to a bottle or other container.

FIG. 3 provides a more detailed schematic cross-sectional view of a first label embodiment produced in accordance with the teachings of my invention prior to its application to a bottle or other container.

FIG. 4 provides a more detailed schematic cross-sectional view of a second label embodiment produced in accordance with the teachings of my invention prior to its application to a bottle or other container.

FIG. 5 provides a schematic perspective view of a label produced in general accordance with FIG. 4 as applied to a nutraceutical bottle. The overlap panel of this label has been peeled back and its adhesive backing is partially covered by a portion of clear laminate adhering thereto.

### DETAILED DESCRIPTION

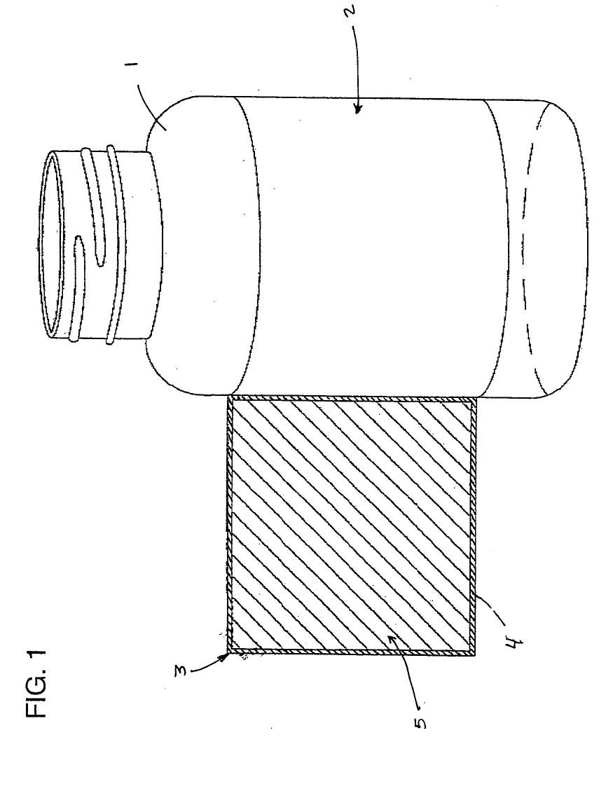

As illustrated in FIG. 1, the labeling system I have invented is generally intended for application to a bottle 1 or similar container. (However, this should not be seen as limiting its basic applicability in other contexts.) As is usual in the art, it includes label parts with printable front surfaces and adhesive-bearing back surfaces. A first label part/portion (denoted generally in the drawing figures by an arrow or bracket 2) is capable of adhering to a box or container such as bottle 1. A second label part/portion (denoted generally in the drawing figures by an arrow or bracket 3) is used to overlap part of first label part/portion 2 (the overlapped portion 2A). Second label part 3 and overlapped portion 2′ can be advantageously formed as part of a single label and located at opposite ends thereof. However, they can also be provided as parts of separate label segments.

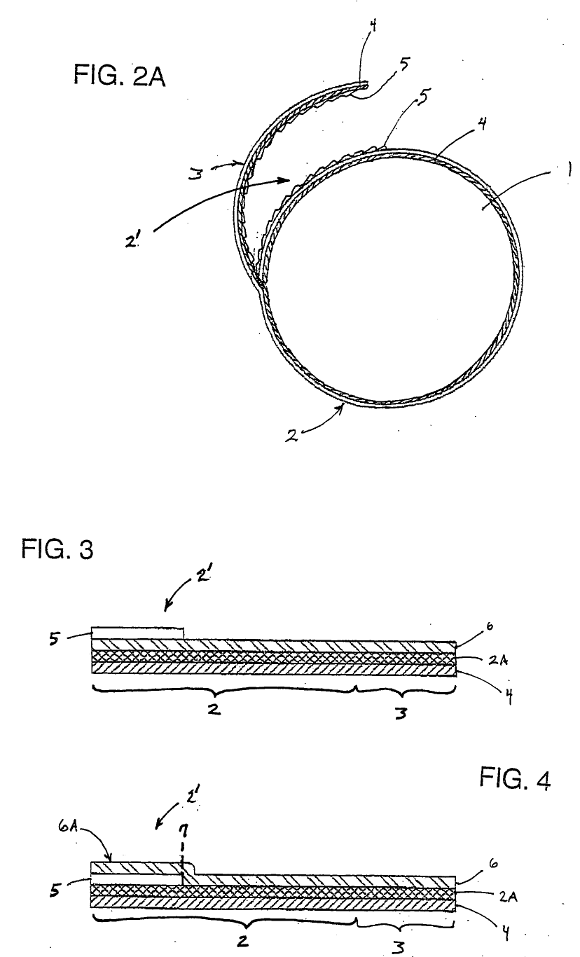

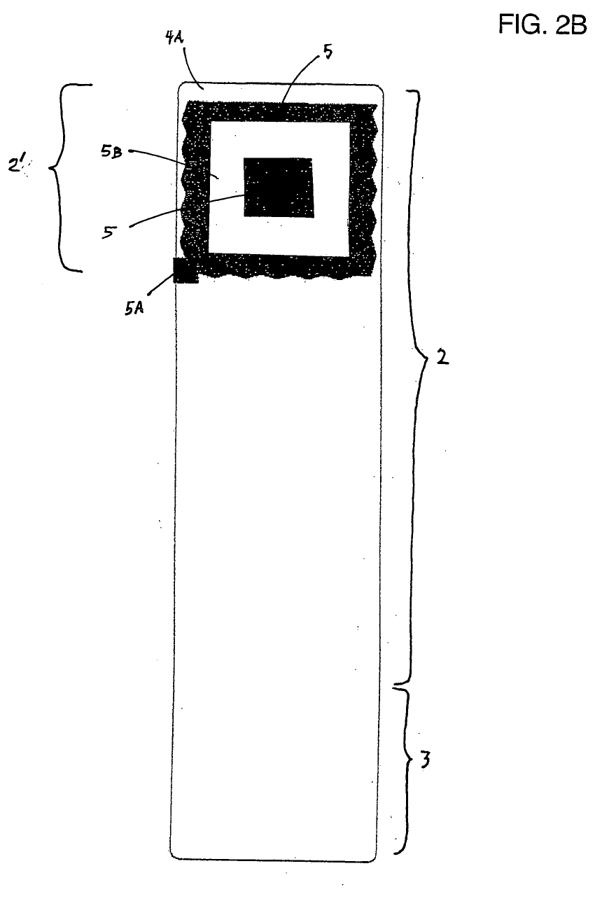

My invention uses “breakaway” surfaces and materials (breakaway imprint 5) rather than “release” surfaces and materials to keep overlap 3 from adhering to first portion 2. Thus, as illustrated in FIGS. 1 and 2, the normal adhesive backing 4 on overlap 3 is at least partially covered, deadened, and/or neutralized by breakaway imprint 5. In the embodiment shown in FIGS. 1 and 2, this leaves only a peripheral area of overlap 3 with its normal adhesive backing 4 un-neutralized and capable of adhering to overlapped portion 2′.

I have discovered that the extender used in and for printing ink provides an excellent printable breakaway substance for use in forming breakaway imprint 5. Extender is basically transparent ink base without any particular color pigment added. It is used in printing to bring a particular ink to the right consistency. Thus, in my invention, a label can be run in standard fashion with pressure sensitive adhesive 4 on its back surface and a normal printed message on its front surface. Then, overlapped portion 2′ receives an additional impress/coating of transparent extender (and primer) “printed” over its printed surface to form breakaway imprint 5. This extender coat can form a full or partial breakaway surface, effectively neutralizing all or almost all of the tackiness of adhesive 4 on the back of overlap 3.

I have also found it useful to print breakaway imprint 5 in certain patterns for the purposes of this invention. (This process is greatly facilitated by the fact that the breakaway substance used in my invention is printable.) Thus, as illustrated in FIG. 2B, it is advantageous to print breakaway imprint 5 so as to leave a peripheral area 4A uncovered by breakaway imprint 5 so that it is free to adhere to overlapped portion 2′. It is also desirable to print breakaway imprint 5 with a serrated edge in areas where overlap 3 can be grasped by a user as this makes it easier for overlap 3 to be peeled up and resealed. Moreover, it is advisable to have breakaway imprint 5 extend to form a corner extension 5A so as to leave an edge corner portion of overlap 3 free from adhesive when overlap 3 is pressed down over breakaway imprint 5. This provides a grab and peel edge/corner for the user, facilitating the release of overlap 3 from first portion 2. When these steps are taken, overlap 3 can be easily and repeatedly peeled off and pressed back into position.

In addition, it is useful to have some uncovered portions 5B in the interior of breakaway imprint 5. First, this aids in maintaining open-and-shut adhesion between overlap 3 and overlapped portion 2′. Second, it makes it possible for breakaway imprint 5 to bear information for security purposes. Even though breakaway imprint 5 is transparent to ordinary light, it can contain a UV brightener that is visible with a UV light or lamp. Thus, when printing breakaway imprint 5, an image (such as the square patterns created in the middle of breakaway imprint 5 in FIG. 2B) can be created directly or reversed out of the pattern of breakaway imprint 5. This image can only be seen with a UV lamp. This feature can be incorporated as an additional security feature, allowing the inclusion of a “hidden” message, symbol, or logo that is only visible under UV light. In sum, breakaway imprint 5 can be printed as a message, symbol or logo or can be printed so as to form a message, symbol or logo out of uncovered portions 5B.

In actual practice, as illustrated in FIGS. 3 and 4, forming a label in accordance with the teaching of my invention usually begins with a plastic film base material 2A with a pressure sensitive adhesive 4 coating its back. (See, FIG. 3). Base material 2A can be polypropylene (BOPP—biaxially oriented polypropylene), polyester, polystyrene, or a similar material. The front surface of base material 2A is first printed at multi-color printing stations with the information (including text and pictures) desired. Next, an over laminate 6 of polypropylene clear film is added to base material 2A to preserve and protect this printing. Finally, a patterned breakaway transfer coating (breakaway imprint 5), made from a formula of extender and primer, is printed on a portion of the top side of over laminate 6. (Overlaminate 6 is not normally ink receptive—this aids in the breakaway of imprint 5 from overlaminate 6.)

Alternately, as illustrated in FIG. 4, breakaway imprint 5 can be printed over base material 2A prior to adding clear overlaminate 6. This alternative provides several interesting options. To begin with, breakaway imprint 5 prevents overlaminate portion 6A from adhering to base material 2A. However, when overlap 3 overwraps laminate portion 6A, it will adhere to this portion. Laminate portion 6A will, in turn, cover and neutralize the adhesive 4 on the bottom of overlap 3. A die cut 7 can be made through laminate 6 between laminate portion 6A and the remainder of laminate 6 (but not through base material 2A). This allows overlap 3 bearing laminate portion 6A to be pulled away from the remainder of label 2. In order to provide some adhesion between overlap 3 and the remainder of label 2, overlap 3 can be slightly longer than laminate portion 6A (so as to contact and adhere to areas of laminate 6 beyond laminate portion 6A).

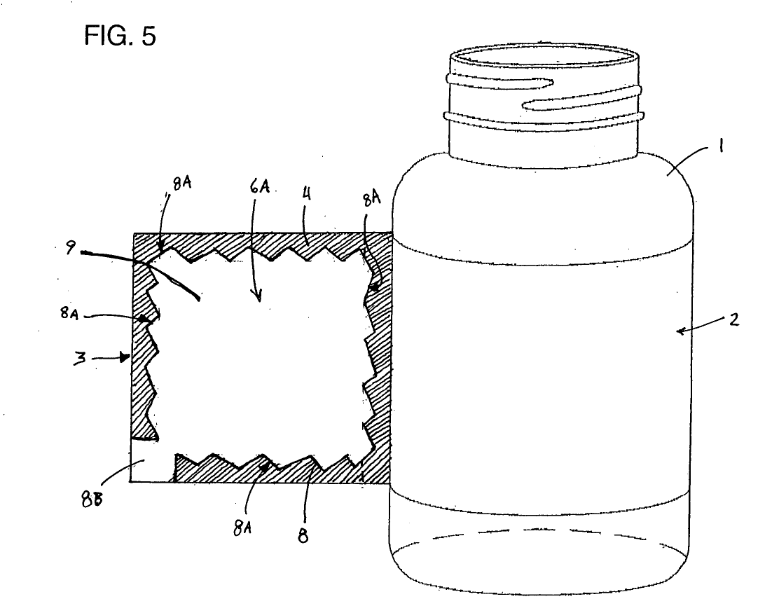

However, a preferred application of this method is illustrated in FIG. 5. In this figure, a single circumferential die cut 8 has been made, defining an interior region 9 of laminate 6A. In keeping with some prior embodiments, this interior region has serrated edges 8A and a corner portion 8B to assist in its use. Breakaway imprint 5 is printed only under interior region 9. Thus, when overlap 3 is pulled away from overlapped portion 2′, die cut 8 allows interior region 9 of laminate portion 6A to adhere to overlap 3 and pull away from the front surface of label 2. This leaves the remaining peripheral area of portion 6A adhered to base material 2A along with the rest of overlaminate 6. Adhesive 4 of overlap 3 adheres to this peripheral area, allowing overlap 3 to be repeatedly peeled off of, and pressed back into position on, the front surface of the overlapped portion 2′ of label 2.

In the alternative illustrated in FIGS. 4 and 5, the upper surface of laminate portion 6A can also be printed before overlap 3 is applied. Generally, clear over laminate 6 is not considered to be suitable for printing because of ink adhesion problems. However, this problem is taken care of in the option being discussed. The top of portion 6A can be printed in mirror image fashion. This printing abuts the adhesive backing 4 on overlap 3, but is visible through the clear over laminate forming portion 6A. Thus, in my invention, the inside as well as the outside of overlap 3 can bear useful information or printing.

In summary, my invention presents a unique and valuable addition to its field and offers unique flexibility and advantages in label design. The foregoing description of preferred embodiments sets forth the best modes presently contemplated for carrying out my invention. However, any details as to materials, quantities, dimensions, and the like are intended as illustrative. The concept and scope of my invention are limited not by the description but only by the following claims and equivalents thereof. Moreover, any terms indicative of orientation are used with reference to drawing illustrations. Such terms are not intended as limitations but as descriptive words. Anything described herein retains its described character whether it is oriented as shown or otherwise.

1. A labeling system, comprising:
a first label part with a printable front surface and an adhesive bearing back surface;
a second label part with a printable front surface and an adhesive bearing back surface, where some portion of said second label part overlaps said first label part such that a portion of the adhesive bearing back surface of said second label part is adjacent an overlapped portion of the front surface of said first label part; and
a printed breakaway substance covering parts of the front surface of said first label part overlapped by said second label part, said printed breakaway substance capable of at least partially neutralizing contacted portions of the adhesive on the back surface of said first label part.

2. A labeling system as described in claim 1, wherein said breakaway substance is formed from extender.

3. A labeling system as described in claim 2, wherein said breakaway substance further includes primer.

4. A labeling system as described in claim 1, wherein a periphery of said overlapped portion is not covered by said breakaway substance.

5. A labeling system as described in claim 4, wherein an area of said periphery is covered by said breakaway substance to form a grab and peel grip for a user.

6. A labeling system as described in claim 1, wherein some interior parts of said overlapped portion are not covered by said breakaway substance.

7. A labeling system as described in claim 1, further comprising a transparent laminate overlaying the overlapped portion and positioned between its printable front surface and said printed breakaway substance.

8. A labeling system as described in claim 1, further comprising a transparent laminate overlaying the overlapped portion and positioned over said printed breakaway substance.

9. A labeling system as described in claim 8, wherein a second portion of said overlaminate overlying the overlapped portion is separable from a first portion of said overlaminate overlying the overlapped portion.

10. A labeling system as described in claim 9, wherein the second portion of said overlaminate has been imprinted.

11. A labeling system as described in claim 10, wherein said imprinting is mirror image imprinting.

12. A labeling system as described in claim 1, wherein said breakaway substance contains a UV brightener.

13. A labeling system as described in claim 12, wherein said breakaway substance is printed so that one of a printed portion thereof and an unprinted portion thereof form a legible symbol.

14. A labeling system as described in claim 1, wherein said first label part and said second label part are at opposite ends of a single label.

15. A labeling system as described in claim 14, wherein the first label part of said label is affixed first to a body and remaining portions of said label encircle the body so that the second label part overlaps the first label part such that the adhesive bearing back surface of said second label part is adjacent the front surface of said first part.

16. A labeling system, comprising:
a label having a printable front surface and an adhesive bearing back surface, the label having a first label part at one end and a second label part at an opposite end, with some portion of said second label part overlapping said first label part such that a portion of the adhesive bearing back surface of said second label part is adjacent an overlapped portion of the front surface of said first label part; and
a printed breakaway substance formed from at least one of extender and primer covering parts of the front surface of said first label part overlapped by said second label part, said printed breakaway substance capable of at least partially neutralizing contacted portions of the adhesive on the back surface of said first label part, and said printed breakaway substance not covering a periphery of said overlapped portion.

17. A labeling system as described in claim 16, wherein an area of said periphery is covered by said breakaway substance to form a grab and peel grip for a user.

18. A labeling system as described in claim 16, wherein some interior parts of said overlapped portion are not covered by said breakaway substance.

19. A labeling system as described in claim 16, further comprising a transparent laminate overlaying the overlapped portion and positioned between its printable front surface and said printed breakaway substance.

20. A labeling system as described in claim 16, further comprising a transparent laminate overlaying the overlapped portion and positioned over said printed breakaway substance.

21. A labeling system as described in claim 20, wherein a second portion of said overlaminate overlying the overlapped portion is separable from a first portion of said overlaminate overlying the overlapped portion.

22. A labeling system as described in claim 21, wherein the second portion of said overlaminate has been imprinted.

23. A labeling system as described in claim 22, wherein said imprinting is mirror image imprinting.

24. A labeling system as described in claim 1, wherein said breakaway substance contains a UV brightener.

25. A labeling system as described in claim 12, wherein said breakaway substance is printed so that one of a printed portion thereof and an unprinted portion thereof form a legible symbol.

26. A labeling system, comprising:
a label with a printable front surface and an adhesive bearing back surface, which label has a first portion capable of encircling a body and a second portion for overlapping said first portion in encircling said body such that the adhesive bearing back surface of said second portion is adjacent the front surface of said first portion;
a printed breakaway substance formed from at least one of extender and primer covering parts of the front surface of said first portion overlapped by said second portion, said printed breakaway substance capable of at least partially neutralizing contacted portions of said adhesive, and a periphery of said first portion being not covered by said breakaway, substance.
